(19) United States
(12) Patent Application Publication
(10) Pub. No.: US 2026/0300924 A1
(43) Pub. Date: Oct. 1, 2026

(54) SYSTEM AND METHOD FOR ITERATIVELY GENERATING A DIGITAL DOCUMENT

(71) Applicant: SAS AIDOCS STUDIO, CASTELNAU-LE-LEZ (FR)

(72) Inventors: Olivier Lopez, CASTELNAU-LE-LEZ (FR); Jean-Michel Cambot, CASTELNAU-LE-LEZ (FR); Mickael Cambot, CASTELNAU-LE-LEZ (FR)

(21) Appl. No.: 19/095,730

(22) Filed: Mar. 31, 2025

(51) Int. Cl. G06Q 10/107; G06F 16/93

(52) U.S. Cl. CPC G06Q 10/107; G06F 16/93

(57) ABSTRACT

The method (300) of iterative document generation comprises at least the steps of: sending (305) a generation SMTP message comprising a digital request of document generation, comprising at least one document generation parameter value, initially generating (310), by the document generator, a digital document as a function of said at least one document generation parameter value, storing (315), on a computing storage, the generated digital document, obtaining (320) an access link to the location of the generated digital document, then, iteratively: sending (325) a message representative of the availability of the generated digital document at the obtained access link, sending (330) a modification SMTP message comprising a digital request of document modification, comprising at least one document modification parameter value, generating (335), by the document generator, a modified digital document and storing (340), on a computing storage, the modified digital document.

### TECHNICAL FIELD OF THE INVENTION

The present invention relates to a system and to a method for iteratively generating a digital document.

The present invention is applicable to the domain workplace automation.

### BACKGROUND OF THE INVENTION

In the field of workplace automation, digital documents corresponding to a specific type (such as a contract) must be generated in a variety of contexts. This variety of cases make automating this generation very complex and has led to an absence of dedicated tools for the last decade.

Previous attempts at document generation required very complex and rigid software, in which only preprogrammed fields or sections of documents could be dynamically adapted.

Recent attempts, based on the availability of generative artificial intelligence (AI) models (and large language models specifically), require users to log into dedicated platforms to generate documents based on series of prompts provided to the generative AI model.

Such systems require significant user cognitive commitment to be learned and differ substantially from the processes of the users know.

Furthermore, such systems exhibit confidentiality and security issues due to their architecture.

For these reasons, adoption of said systems is slow.

### SUMMARY OF THE INVENTION

The present invention is intended to remedy all or part of these disadvantages.

To this effect, according to a first aspect, the present invention aims at a method of iterative document generation, which comprises at least the steps of:
sending a generation SMTP message, from a computing device associated with a user to a document generator, comprising a digital request of document generation, comprising at least one document generation parameter value,
initially generating, by the document generator, a digital document as a function of said at least one document generation parameter value,
storing, on a computing storage, the generated digital document,
obtaining an access link to the location of the digital document generated on the computer storage,
then, iteratively:
   sending, to a computing device associated with said user, a message representative of the availability of the generated digital document at the obtained access link,
   sending a modification SMTP message, from a computing device associated with said user to a document generator, comprising a digital request of document modification, comprising at least one document modification parameter value,
   generating, by the document generator, a modified digital document as a function of said at least one document modification parameter value and of the said at least one document generation parameter value, and
   storing, on a computing storage, the modified digital document.

Such provisions allow users to, while maintaining their habits, obtain automatically generated digital documents and perform work on said documents to iteratively modify said documents until satisfied.

Furthermore, such provisions provide more confidential features, not requiring users to provide confidential information onto an online platform.

In particular embodiments, the method object of the present invention further comprises, prior to the step of sending a modification SMTP message, the steps of:
selecting, upon a computing device, a part of the generated or modified digital document, and
associating, upon a computer device, at least one document modification parameter value in relation to said selected part,
the step of sending a modification SMTP message being performed as a function of the at least one document modification parameter value in relation to said selected part.

Such embodiments allow for the local generation of modifications of a document, based on the selected part and on the content of modification parameters.

In particular embodiments, the method object of the present invention further comprises, prior to the step of initially generating, the steps of:
collecting, upon a computing storage, at least one previously available digital document,
anonymizing, by a computing device, the content of the collected at least one digital document,
tagging, by a computing device, the content of anonymized content of the collected at least one digital document,
said tagged anonymized content being used during the step of generating a digital document.

Such embodiments allow for the generation of templates to be used during the steps of generating, in a confidential and secure manner. In such embodiments, the tagging in place allows for the accurate selection of a template upon generation.

In particular embodiments, the method object of the present invention further comprises at least one of the steps of:
classifying the collected documents,
summarizing the collected documents,
converting at least one collected document to text format,
checking that type of at least one collected document corresponds to a predetermined expected document type,
identifying segments of the at least one collected document,
evaluating the quality of the at least one collected document.

Such embodiments allow for the generation of templates to be used during the steps of generating, in a confidential and secure manner. In such embodiments, the tagging in place allows for the accurate selection of a template upon generation.

In particular embodiments, the method object of the present invention further comprises, prior to the step of initially generating, a step of configuring at least one document generation rule, at least one step of generating being performed as a function of said configured at least one document generation rule.

Such embodiments allow for the generation of digital documents which respect the configured generation rules. This, in turn, ensures the accuracy and veracity of the generated document, thus reducing the need for downstream modification iteration cycles.

In particular embodiments, the method object of the present invention further comprises, after a step of generating, a step of operating an agent configured to confirm or infirm the conformity of the digital document to the at least one document generation or modification parameter value sent.

Such embodiments allow for the automated verification of the conformity of the document generated in regard to the instruction generation.

In particular embodiments, the method object of the present invention further comprises, after a step of generating, a step of operating an agent configured to confirm or infirm the quality of the digital document to at least one document generation or modification parameter value sent.

Such embodiments allow for the automated verification of the quality of the generated document.

In particular embodiments, the method object of the present invention further comprises, after a step of generating, a step of operating an agent configured to confirm or infirm the veracity of the digital document to the at least one document generation or modification parameter value sent.

Such embodiments allow for the automated verification of the veracity of the generated document.

In particular embodiments, the method object of the present invention further comprises, after a step of generating, a step of operating an agent configured to confirm or infirm the coherency of the digital document to the at least one document generation or modification parameter value sent.

Such embodiments allow for the automated verification of the coherency of the generated document.

In particular embodiments, the method object of the present invention further comprises, after a step of operating, if the respect of the corresponding criteria is infirmed by the agent, the step of creating a digital request of document generation, comprising at least one document modification parameter value, the step of generating being further performed as a function of said at least one document modification parameter value.

Such embodiments allow for the automatic regeneration of documents not meeting at least one of the criteria checked by an agent.

According to a second aspect, the present invention aims at a system of iterative document generation, which comprises at least:
an output device, configured to send a generation SMTP message, from a computing device associated with a user to a document generator, said message comprising a digital request of document generation, comprising at least one document generation parameter value, said computing device, a document generator, configured to initially generate a digital document as a function of said at least one document generation parameter value,
said computing device,
a document generator, configured to initially generate a digital document as a function of said at least one document generation parameter value,
storing means, configured to store the generated digital document on computing storage,
said computing storage,
access link obtaining means, configured to obtain an access link to the location of the generated digital document on the computer storage,
an output device configured to iteratively send to a computing device associated with said user, a message representative of the availability of the generated digital document at the obtained access link,
an output device, configured to send a modification SMTP message, from a computing device associated with said user to a document generator, comprising a digital request of document modification, comprising at least one document modification parameter value,
the document generator further configured to generate a modified digital document as a function of said at least one document modification parameter value and of the said at least one document generation parameter value, and
the storing means further configured to store the modified digital document on the computer storage.

According to a third aspect, the present invention aims at a computer program product characterized in that it comprises instructions which upon execution by a computer cause the computer to execute the method according to the present invention.

According to a fourth aspect, the present invention aims at a computer-readable storage medium storing programming instructions which upon execution by a computer cause the computer to execute the method according to the present invention.

The second, third and fourth aspects object of the present invention provides the same advantages as the first aspect object of the present invention.

### BRIEF DESCRIPTION OF THE DRAWINGS

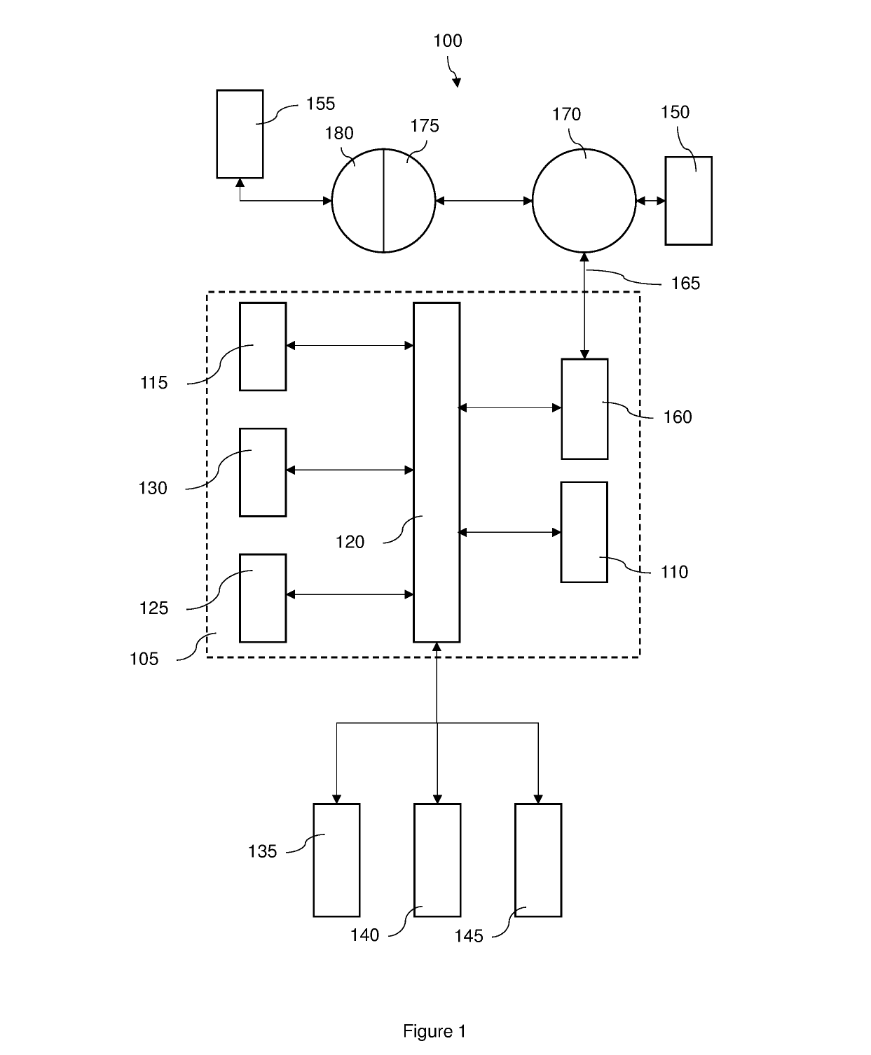

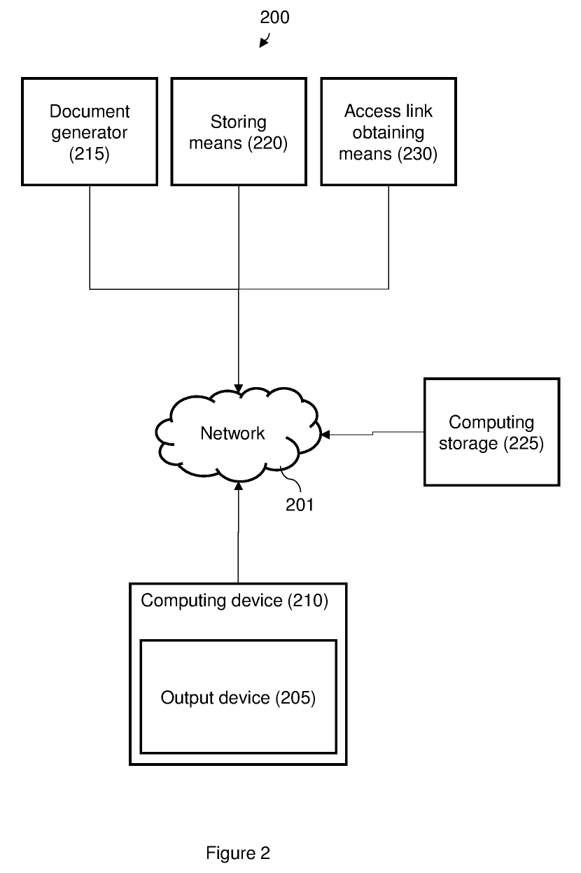

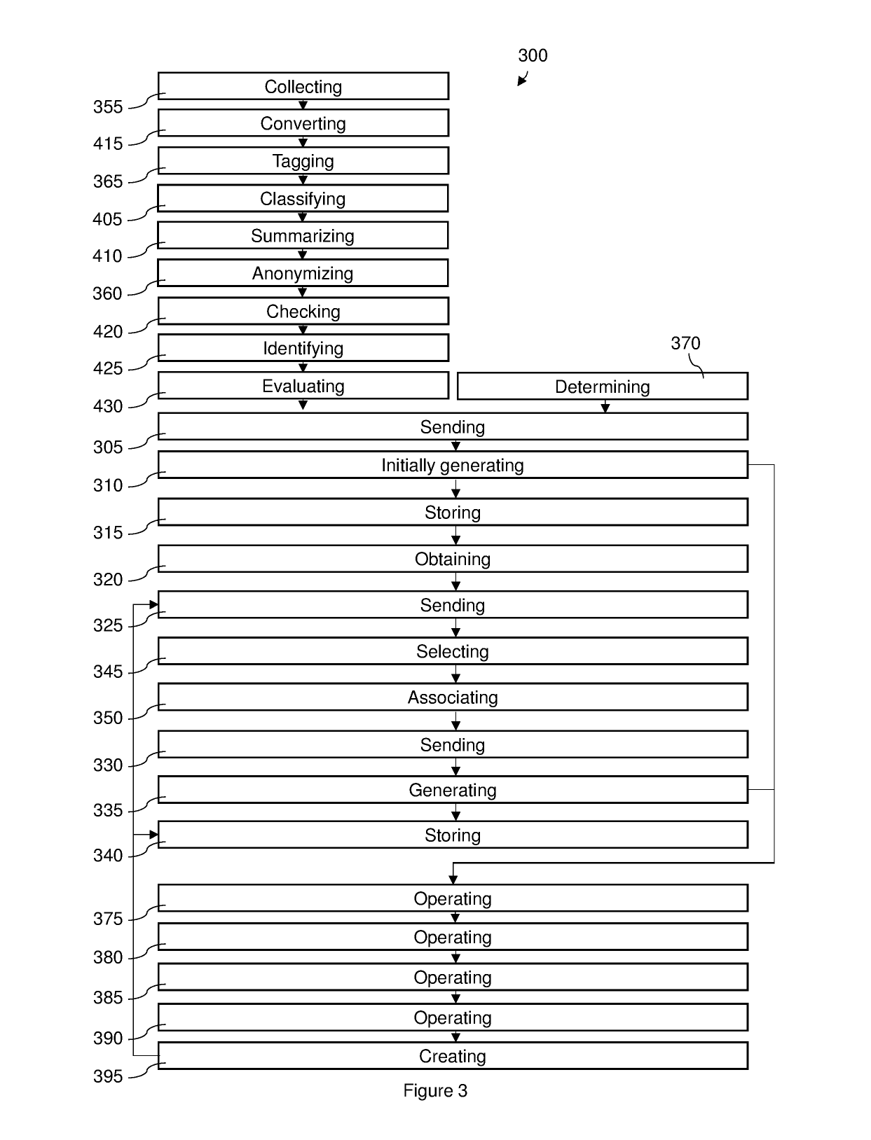

Other advantages, purposes and particular characteristics of the invention shall be apparent from the following non-exhaustive description of at least one particular embodiment of the present invention, in relation to the drawings annexed hereto, in which:

[FIG. 1] represents, schematically, a computer system with which an embodiment of the method subject of the present invention can be implemented,

[FIG. 2] represents, schematically, a particular embodiment of a system of the present invention can be implemented, and

[FIG. 3] represents, schematically, a particular embodiment of the method object of the present invention.

### DETAILED DESCRIPTION OF THE INVENTION

This description is not exhaustive, as each feature of one embodiment may be combined with any other feature of any other embodiment in an advantageous manner. Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles ‘a’ and ‘an’, as used herein in the specification and in the claims, unless clearly indicated to the contrary, should be understood to mean ‘at least one’.

The phrase ‘and/or’, as used herein in the specification and in the claims, should be understood to mean ‘either or both’ of the elements so conjoined, i.e., elements that are conjunctively present in some cases and disjunctively present in other cases. Multiple elements listed with ‘and/or’ should be construed in the same fashion, i.e. ‘one or more’ of the elements so conjoined. Other elements may optionally be present other than the elements specifically identified by the ‘and/or’ clause whether related or unrelated to those elements specifically identified. Thus, as a non-limiting example, a reference to ‘A and/or B’, when used in conjunction with open-ended language such as ‘comprising’ can refer, in one embodiment, to A only (optionally including elements other than B); in another embodiment, to B only (optionally including elements other than A); in yet another embodiment, to both A and B (optionally including other elements); etc.

As used herein in the specification and in the claims, ‘or’ should be understood to have the same meaning as ‘and/or’ as defined above. For example, when separating items in a list, ‘or’ or ‘and/or’ shall be interpreted as being inclusive, i.e., the inclusion of at least one, but also including more than one of a number or list of elements, and, optionally, additional unlisted items. Only terms clearly indicated to the contrary, such as ‘only one of’ or ‘exactly one of’, or, when used in the claims, ‘consisting of’, will refer to the inclusion of exactly one element of a number or list of elements. In general, the term ‘or’ as used herein shall only be interpreted as indicating exclusive alternatives (i.e. ‘one or the other but not both’) when preceded by terms of exclusivity, such as ‘either,’ ‘one of,’ ‘only one of’, or ‘exactly one of’. ‘Consisting essentially of,’ when used in the claims, shall have its ordinary meaning as used in the field of patent law.

As used herein in the specification and in the claims, the phrase ‘at least one’, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase ‘at least one’ refers, whether related or unrelated to those elements specifically identified. Thus, as a non-limiting example, ‘at least one of A and B’ (or, equivalently, ‘at least one of A or B’, or, equivalently ‘at least one of A and/or B’) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as ‘comprising,’ ‘including,’ ‘carrying,’ ‘having,’ ‘containing,’ ‘involving,’ ‘holding,’ ‘composed of’, and the like are to be understood to be open-ended, i.e., to mean including but not limited to. Only the transitional phrases ‘consisting of’ and ‘consisting essentially of’ shall be closed or semi-closed transitional phrases, respectively.

In the context of this invention, a “document” or “digital document” refers to any structured digital entity that contains information in a format that can be read, edited, and stored. It typically consists of text, images, and other media, organized in a way that conveys meaning and context. Documents can be created and managed using various software applications, such as word processors, spreadsheets, or PDF editors, and are often stored in specific file formats like DOCX, PDF, or XLSX.

In the context of this invention, a “document generation parameter value” refers to the specific data or input provided to a document generation system that influences the content or format of the generated document. These values are used to customize the output based on predefined parameters, such as text fields, numerical values, dates, or other variables. For example, in a document generation process, a parameter value could be the name of a client, a specific date, or a currency amount that is inserted into a document template.

In the context of this invention, an “access link” refers to a URL or hyperlink that provides direct access to a specific document stored in a digital storage system, such as cloud storage, a database, or a content management system. This link can allow users to retrieve, view, or download the document without needing to navigate through the storage system's interface.

In the context of this invention, a “digital request” refers to an electronic instruction or command sent to a computer to perform a specific task or retrieve particular information. This request can originate from various sources, such as user input through a keyboard or mouse, network communications, or other software applications.

In the context of this invention, a “document generation rule” refers to a predefined set of instructions or conditions that govern the creation and assembly of documents within a document generation system. These rules dictate how data is retrieved, processed, and inserted into document templates to produce the final output.

In particular variants, at least one document generation rule can correspond to conditional logic that determines which content, or sections should be included or excluded based on specific criteria. For example, a rule might specify that a particular clause should only be added if certain conditions are met.

In particular variants, at least one document generation rule can correspond to data mapping, which involves linking data fields from sources like databases or user inputs to placeholders within the document template. This ensures that the correct information is inserted into the appropriate places in the document.

In particular variants, at least one document generation rule can correspond to formatting guidelines. These guidelines ensure that the text, images, and other elements within the document are presented in a consistent manner. They may specify fonts, styles, and layouts to be used, enhancing the overall quality and readability of the document.

In particular variants, at least one document generation rule can correspond to business rules which ensure that the generated documents adhere to organizational policies, legal requirements, or other business constraints. For instance, a business rule might enforce that all contracts include specific legal disclaimers or that financial reports follow a particular format.

In particular variants, at least one document generation rule can correspond to template selection which corresponds to rules help in choosing the appropriate document template.

In the context of this invention, “veracity” refers to the accuracy, reliability, and trustworthiness of generated documents.

In the context of this invention, “conformity” refers to the adherence of generated documents to predefined standards, regulations, specifications or instructions input by a user or another system.

In the context of this invention, “quality” refers to the degree to which the generated documents meet established standards of accuracy and consistency.

In the context of this invention, “coherency” refers to the logical consistency and seamless integration of various elements within a document, ensuring that the final output is clear, unified, and free from contradictions.

In the context of this invention, the terms “means of inputting” or “means of uploading” refer to, for example, a keyboard, mouse and/or touchscreen adapted to interact with a computing system in such a way to collect user input. In variants, the means of inputting are logical in nature, such as a network port of a computing system configured to receive an input command transmitted electronically. Such input means may be associated with a GUI (Graphic User Interface) shown to a user or an API (Application programming interface). In other variants, the means of inputting may be a sensor configured to measure a specified physical parameter relevant for the intended use case. Examples of means of inputting are disclosed in regard to FIG. 1.

As used herein, the terms “computing system”, “computer”, or “computer system” designate any electronic calculation device, whether unitary or distributed, capable of receiving numerical inputs and providing numerical outputs by and to any sort of interface, digital and/or analog. Typically, a computing system designates either a computer executing software having access to data storage or a client-server architecture wherein the data and/or calculation is performed at the server side while the client side acts as an interface. Examples of such computing systems are disclosed in regard to FIG. 1.

As used herein, the term “database” refers to any physical and/or virtual storage of data. Such a database can refer to a computer memory accessible in a computer network, upon which a database management system is run. In simpler embodiments, a database can correspond to a table stored in a computer memory. Such a table may be stored in a document, such as a Microsoft Excel document.

It should be understood that, in the context of the present document, a “computer interface” may correspond to a graphic or software interface. In the context of a graphic user interface (or GUI), a user may perform a number of potential actions, such as selecting an item from a list or inputting alphanumeric characters in an input field.

FIG. 1 further represents a block diagram that illustrates an example computer system 100 with which an embodiment of the present invention may be implemented. In the example of FIG. 1, a computer system 105 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

The computer system 105 includes an input/output (IO) subsystem 120 which may include a bus and/or other communication mechanism(s) for communicating information and/or instructions between the components of the computer system 105 over electronic signal paths. The I/O subsystem 120 may include an I/O controller, a memory controller and at least one I/O port. The electronic signal paths are represented schematically in the drawings, for example as lines, unidirectional arrows, or bidirectional arrows.

At least one hardware processor 110 is coupled to the I/O subsystem 120 for processing information and instructions. Hardware processor 110 may include, for example, a general-purpose microprocessor or microcontroller and/or a special-purpose microprocessor such as an embedded system or a graphics processing unit (GPU) or a digital signal processor or ARM processor. Processor 110 may comprise an integrated arithmetic logic unit (ALU) or may be coupled to a separate ALU.

Computer system 105 includes one or more units of memory 125, such as a main memory, which is coupled to I/O subsystem 120 for electronically digitally storing data and instructions to be executed by processor 110. Memory 125 may include volatile memory such as various forms of random-access memory (RAM) or other dynamic storage devices. Memory 125 also may be used for storing temporary variables or other intermediate information during execution of instructions to be executed by processor 110. Such instructions, when stored in non-transitory computer-readable storage media accessible to processor 110, can render computer system 105 into a special-purpose machine that is customized to perform the operations specified in the instructions.

Computer system 105 further includes non-volatile memory such as read only memory (ROM) 130 or other static storage device coupled to the I/O subsystem 120 for storing information and instructions for processor 110. The ROM 130 may include various forms of programmable ROM (PROM) such as erasable PROM (EPROM) or electrically erasable PROM (EEPROM). A unit of persistent storage 115 may include various forms of non-volatile RAM (NVRAM), such as FLASH memory, or solid-state storage, magnetic disk, or optical disk such as CD-ROM or DVD-ROM and may be coupled to I/O subsystem 120 for storing information and instructions. Storage 115 is an example of a non-transitory computer-readable medium that may be used to store instructions and data which when executed by the processor 110 cause performing computer-implemented methods to execute the techniques herein.

The instructions in memory 125, ROM 130 or storage 115 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, Internet access applications, design and manufacturing applications, graphics applications, audio applications, software engineering applications, educational applications, games or miscellaneous applications. The instructions may be implemented by a web server, web application server or web client. The instructions may be organized as a presentation layer, application layer and data storage layer such as a relational database system using structured query language (SQL) or no SQL, an object store, a graph database, a flat file system or other data storage.

Computer system 105 may be coupled via I/O subsystem 120 to at least one output device 135. In one embodiment, output device 135 is a digital computer display or Human Machine Interface. Examples of a display that may be used in various embodiments include a touchscreen display or a light-emitting diode (LED) display or a liquid crystal display (LCD) or an e-paper display. Computer system 105 may include other type(s) of output devices 135, alternatively or in addition to a display device. Examples of other output devices 135 include printers, ticket printers, plotters, projectors, sound cards or video cards, speakers, buzzers or piezoelectric devices or other audible devices, lamps or LED or LCD indicators, haptic devices, actuators, or servos.

At least one input device 140 is coupled to I/O subsystem 120 for communicating signals, data, command selections or gestures to processor 110. Examples of input devices 140 include touchscreens, microphones, still and video digital cameras, alphanumeric and other keys, keypads, keyboards, graphics tablets, image scanners, joysticks, clocks, switches, buttons, dials, slides.

Another type of input device is a control device 145, which may perform cursor control or other automated control functions such as navigation in a graphical interface on a display screen, alternatively or in addition to input functions. Control device 145 may be a touchpad, a mouse, a trackball, or cursor direction keys for communicating direction information and command selections to processor 110 and for controlling cursor movement on display 135. The input device may have at least one degree of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 140 may include a combination of multiple different input devices, such as a video camera and a depth sensor.

In another embodiment, computer system 105 may comprise an Internet of things (IoT) device in which one or more of the output device 135, input device 140, and control device 145 are omitted. Or, in such an embodiment, the input device 140 may comprise one or more cameras, motion detectors, thermometers, microphones, seismic detectors, other sensors or detectors, measurement devices or encoders and the output device 135 may comprise a special-purpose display such as a single-line LED or LCD display, one or more indicators, a display panel, a meter, a valve, a solenoid, an actuator or a servo.

Computer system 105 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 105 in response to processor 110 executing at least one sequence of at least one instruction contained in main memory 125. Such instructions may be read into main memory 125 from another storage medium, such as storage 115. Execution of the sequences of instructions contained in main memory 125 causes processor 110 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 115. Volatile media includes dynamic memory, such as memory 125. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 120. Transmission media can also take the form of acoustic or light waves, such as those generated during radio-wave and infrared data communications.

Various forms of media may be involved in carrying at least one sequence of at least one instruction to processor 110 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 105 can receive the data on the communication link and convert the data to a format that can be read by computer system 105. For instance, a receiver such as a radio frequency antenna or an infrared detector can receive the data carried in a wireless or optical signal and appropriate circuitry can provide the data to I/O subsystem 120 such as place the data on a bus. I/O subsystem 120 carries the data to memory 125, from which processor 110 retrieves and executes the instructions. The instructions received by memory 125 may optionally be stored on storage 115 either before or after execution by processor 110.

Computer system 105 also includes a communication interface 160 coupled to bus 120. Communication interface 160 provides a two-way data communication coupling to network link(s) 165 that are directly or indirectly connected to at least one communication network, such as a network 170 or a public or private cloud on the Internet. For example, communication interface 160 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 170 broadly represents a local area network (LAN), wide-area network (WAN), campus network, internet, or any combination thereof. Communication interface 160 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 160 sends and receives electrical, electromagnetic, or optical signals over signal paths that carry digital data streams representing various types of information.

Network link 165 typically provides electrical, electromagnetic, or optical data communication directly or through at least one network to other data devices, using, for example, satellite, cellular, Wi-Fi, or BLUETOOTH technology. For example, network link 165 may provide a connection through a network 170 to a host computer 150.

Furthermore, network link 165 may provide a connection through network 170 or to other computing devices via internetworking devices and/or computers that are operated by an Internet Service Provider (ISP) 175. ISP 175 provides data communication services through a world-wide packet data communication network represented as Internet 180. A server computer 155 may be coupled to Internet 180. Server 155 broadly represents any computer, data center, virtual machine, or virtual computing instance with or without a hypervisor, or computer executing a containerized program system such as DOCKER or KUBERNETES. Server 155 may represent an electronic digital service that is implemented using more than one computer or instance and that is accessed and used by transmitting web services requests, uniform resource locator (URL) strings with parameters in HTTP payloads, API calls, app services calls, or other service calls. Computer system 105 and server 155 may form elements of a distributed computing system that includes other computers, a processing cluster, server farm or other organization of computers that cooperate to perform tasks or execute applications or services. Server 155 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, Internet access applications, design and manufacturing applications, graphics applications, audio applications, software engineering applications, educational applications, games or miscellaneous applications. Server 155 may comprise a web application server that hosts a presentation layer, application layer and data storage layer such as a relational database system using structured query language (SQL) or no SQL, an object store, a graph database, a flat file system or other data storage.

Computer system 105 can send messages and receive data and instructions, including program code, through the network(s), network link 165 and communication interface 160. In the Internet example, a server 155 might transmit a requested code for an application program through Internet 180, ISP 175, local network 170 and communication interface 160. The received code may be executed by processor 110 as it is received, and/or stored in storage 115, or other non-volatile storage for later execution.

The execution of instructions as described in this section may implement a process in the form of an instance of a computer program that is being executed and consists of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 110. While each processor 110 or core of the processor executes a single task at a time, computer system 105 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

FIG. 2 depicts a particular embodiment of a method 300 of iterative document generation, which comprises at least the steps of:
sending 305 a generation message, from a computing device associated with a user to a document generator, comprising a digital request of document generation, comprising at least one document generation parameter value,
initially generating 310, by the document generator, a digital document as a function of said at least one document generation parameter value,
storing 315, on a computing storage, the generated digital document,
obtaining 320 an access link to the location of the generated digital document on the computer storage,
then, iteratively:
   sending 325, to a computing device associated with said user, a message representative of the availability of the generated digital document at the obtained access link,
   sending 330 a modification SMTP message, from a computing device associated with said user to a document generator, comprising a digital request of document modification, comprising at least one document modification parameter value,
   generating 335, by the document generator, a modified digital document as a function of said at least one document modification parameter value and of the said at least one document generation parameter value,
   storing 340, on a computing storage, the modified digital document.

During the step of sending 305 a generation message, an input device, such as disclosed in regard to FIG. 1, or means of input can be used. The generation message may correspond to a SMTP (for Simple Mail Transfer Protocol) message, which corresponds to an email for example.

During this step of sending 305, instructions corresponding to computer software may be executed by a computing system or device. Such instructions may correspond to the retrieval of a request of document generation obtained from a user or another computing system and to the sending of the retrieved request to the document generator.

The request of document generation corresponds, for example, to a text request drafted by a computing system, via an API for example, or by a user, via a GUI for example. This request may be associated with attachments to be used by the document generator.

The request of document generation comprises at least one document generation parameter value, which can correspond to, for example at least one of:
a type of document,
a document template,
an address,
names of parties in the document, and/or
a currency.

The request for document generation may further comprise additional commands to be executed by the document generator or a corresponding secondary system.

Such an additional command may correspond to, for example:
a command to evaluate the quality of a document attached to the request of document generation comprises,
a language of the document,
an applicable law for the document, and/or
transformer model to be used for document generation.

The step of sending 305 may be performed on a local terminal, such as a computer or smartphone, for example, the document generator being executed by a computing server accessible via a computer network, such as the Internet for example.

In particular variants, the method 300 object of the present invention further comprises a step of receiving a message comprising a request for further instructions, triggered if the document generator is not able to process the instruction in the initially sent message. Such a step of receiving may be performed if, for example, a document is missing in the attachments of an email, despite instructions in the message referring to said document.

In particular embodiments, the method 300 object of the present invention further comprises a step of selecting at least one document in a knowledge base to be used for document generation as a function of the sent message.

In particular variants, this selection is performed as a function of tags associated, by a transformer, to the request for document generation on one hand and of tags associated, by a transformer, to documents available in a knowledge base. In such variants, at least one document is selected if this document has the most tags in common with the request. Optionally, this document is selected if a metric (score) representative of the quality of this document is above a defined threshold.

The step of initially generating 310 can be performed by instructions corresponding to computer software which may be executed by a computing system or device. Such instructions may correspond to the use of a transformer model (such as an LLM, for Large Language Model, for example). Such a LLM can correspond to, for example, a LLM produced by OpenAI, Mistral, Meta or Deepseek for example. The transformer model can be used directly with the received request of document generation or after a step of optimizing the request of document generation.

The request of document generation may comprise static elements and dynamic elements (variable) which are set as a function of the sent message.

In such variants, for example, a static prompt comprises variables which are set as a function of the sent message.

The term “document generator” refers to any type of digital system which aims at producing a document based on a request of document generation.

The output of the step of initially generating 310 is a generated document.

The step of storing 315 can be performed by instructions corresponding to computer software which may be executed by a computing system or device.

During the step of storing 315, the generated document is stored in a computer memory of any kind, such as shown in FIG. 1.

The generated document can be stored in online cloud storage, for example. Such online cloud storage can correspond to a Microsoft SharePoint server, for example.

The step of obtaining 320 can be performed by instructions corresponding to computer software which may be executed by a computing system or device.

During the step of obtaining 320, an access link, which corresponds to a URL (for Unique Resource Location) is obtained and stored in a computer memory of any kind, such as shown in FIG. 1.

The obtained access link can be stored in a temporary memory, such as RAM (for Random Access Memory), for example.

The step of sending 325 can be performed by instructions corresponding to computer software which may be executed by a computing system or device.

During the step of sending 325, a message, which can correspond to a SMTP message, is sent. This message is sent, for example, to a recipient which corresponds to a user responsible for establishing the initial request for document generation. Alternatively, this message is sent to a predetermined address or to a configurable address. Alternatively, this message is sent to an address specified in the message comprising the request for document generation.

This message comprises the obtained access link which can be used by a user or system to access the generated document.

Once the document is accessed, a user or system may want to modify the generated document to some capacity. The user or system can modify the generated document using any document processing tool.

The step of sending 330 can be performed by instructions corresponding to computer software which may be executed by a computing system or device.

During the step of sending 330, an SMTP message is sent. This message is sent to a document generator, which can be the same as the document generator used during the step of initially generating 310.

This step of sending 330 may be performed by using a comment feature of a document processing tool, the publication of said comment automatically triggering the sending of a SMTP message to the document generator which comprises the content of the comment and/or the content of all previous comments relative to the selected part of the document. In particular variants, a tool identifier (such as “@document generator”) is be added to the comment prior to publication. Such tool identifier can correspond to the @mention feature of Microsoft Word, for example.

The SMTP message comprises at least one document modification parameter value, which can correspond to a prompt written in plain text by a user for example. Such a document modification parameter value may correspond to a text prompt which is analyzed and processed by the transformer, said text prompt comprising modification instructions relative to the document.

The step of generating 335 can be performed by instructions corresponding to a computer software which may be executed by a computing system or device.

During the step of generating 335, the document generator uses the at least one document modification parameter value to generate a modified version of the generated document. This modified version can correspond to an entirely generated document or to a newly generated section of the existing document.

In particular variants, the initial at least one document generation parameter value are used during the step of generating 335.

In particular variants, the previous iteration of the generated document is used during the step of generating 335.

The generated document can, during the step of generating 335, correspond to solely a part of the initially generated document.

In particular variants, the part of the generated part of the document modified upon receiving a modification request is provided in response to the sent SMTP message. In such variants, this generated part is provided in a comment of the document, in response to a comment comprising the modification request.

The step of storing 340 can be performed by instructions corresponding to a computer software which may be executed by a computing system or device.

The step of storing 340 may be performed in a similar fashion to the step of storing 31 described above.

In particular embodiments, such as the one shown in FIG. 3, the method 300 object of the present invention further comprises, prior to the step of sending 330 a modification SMTP message, the steps of:
selecting 345, upon a computing device, a part of the generated or modified digital document, and
associating 350, upon a computer device, at least one document modification parameter value in relation to said selected part,
the step of sending a modification SMTP message being performed as a function of the at least one document modification parameter value in relation to said selected part.

The step of selecting 345 can be performed by instructions corresponding to computer software which may be executed by a computing system or device.

During the step of selecting 345, a part of the generated or modified document is selected by performing text selection with the cursor of a mouse or a keyboard used by a user, for example.

The step of associating 350 can be performed by instructions corresponding to computer software which may be executed by a computing system or device.

During the step of associating 350, for example, an action to associate a comment with the selected part of the document is undertaken by a user, the at least one document modification parameter value being provided in said comment.

In particular embodiments, such as the one shown in FIG. 3, the method 300 object of the present invention further comprises, prior to the step of initially generating 310, the steps of:
collecting 355, upon a computing storage, at least one previously available digital document,
anonymizing 360, by a computing device, the content of the collected at least one digital document,
tagging 365, by a computing device, the content of anonymized content of the collected at least one digital document,
said tagged anonymized content being used during the step of generating, 310 and/or 335, a digital document.

The step of collecting 355 can be performed, automatically, by instructions corresponding to computer software which may be executed by a computing system or device.

The step of collecting 355 can also be performed with user input, said user selecting documents to be collected and used downstream.

The documents collected can be arranged in several collections, each collection corresponding to a type of document, for example.

Such collections may refer to, for example:
Commercial - Commercial contract
Commercial - Competition & consumer law
Commercial - Compliance & personal data (GDPR)
Commercial - Insurance
Commercial - Intellectual property
Commercial - International economic sanctions / countries under embargo
Commercial - Media / Communication and entertainment
Commercial - Technology and e-commerce
Corporate - Governance
Corporate - M&A Corporate - Private Equity
Corporate - Venture Capital
Dispute - Arbitration
Dispute - Criminal litigation
Dispute - Litigation & dispute resolution
Dispute - Restructuring & insolvency
Employment Employment
Employment - Social protection
Financing - Banking
Financing - Capital markets - stock exchange law
Public law - Environment
Public law - Public liability
Public law - Urban planning
Real Estate - Construction
Real Estate - Management (leasing)
Real Estate - Transactions
Tax - Corporate
Tax - Estate planning
Tax - International mobility
Tax - Tax dispute

In particular variants, during the step of collecting 355, documents are extracted from email correspondence of a group of at least one user.

In particular variants, the type of documents that can be collected can be set by rules, such as limiting to particular document extensions for example or to specific locations, such as email accounts or registries.

The step of anonymizing 360 can be performed by instructions corresponding to computer software which may be executed by a computing system or device.

During the step of anonymizing 360, any personally identifiable information is removed or obscured to protect the privacy of individuals mentioned within it. Such removal or obscurement comprises, for example, steps of redacting names, addresses, phone numbers, email addresses, and other unique identifiers. Such removal or obscurement comprises, for example, steps of replacing real data with pseudonyms, aggregating data to prevent individual identification, or using differential privacy methods to add noise to the data.

The step of tagging 365 can be performed by instructions corresponding to a computer software which may be executed by a computing system or device.

During the step of tagging 365, metadata labels, or “tags”, are associated with specific elements within the document to categorize and organize information. This step of tagging 365, for example, comprises steps of identifying and marking key entities such as names, dates, locations, and other relevant data points using predefined labels. Techniques used may involve natural language processing (NLP) or transformer algorithms to automatically detect and tag entities, or manual annotation by human reviewers. Such tags may be performed as a function of an explicit tagging request to a transformer algorithm, for example.

In such embodiments, the tagged and anonymized content is used during at least one step of generating, 310 and/or 335, a digital document.

In particular embodiments, the method 300 object of the present invention further comprises at least one of the steps of:
converting 415 the document to text format,
classifying 405 the collected documents,
summarizing 410 the collected documents,
checking 420 that type of the document corresponds to a predetermined expected document type,
identifying 425 segments of the document (such as clauses in a contract), and/or
evaluating 430 the quality of the document.

In particular variants, the processing of collected documents is distributed among local and distant computing devices or capabilities.

For example, the conversion of a document to text, the anonymization and the evaluation of quality may be performed locally, that is in a local computer network.

For example, the checking of the type of document, the classification, the tagging, the summarization, and the segment identification may be performed remotely.

The step of converting 415 can be performed by instructions corresponding to computer software which may be executed by a computing system or device.

Such a step of converting 415 may use, for example, OCR (for optic character recognition) algorithms upon documents which may be in PDF format, for example.

In other variants, XML may be parsed to extract the text content of a DOCX document, for example.

The step of classifying 405 can be performed by instructions corresponding to computer software which may be executed by a computing system or device.

During the step of classifying 405, documents can be classified in a predetermined classification system (defined by a user, for example), such as by type of document, or into an automatically generated classification system, defined by a transformer itself as a function of all collected documents.

The step of classifying 410 can be performed by instructions corresponding to computer software which may be executed by a computing system or device.

During the step of summarizing 410, a prompt representative of a request for summarization can be provided to a transformer and the result stored in a database or computer storage.

The step of checking 420 can be performed by instructions corresponding to computer software which may be executed by a computing system or device.

During the step of checking 420, a prompt representative of a request for verification of the appropriate correspondence between the document type and expected document types can be provided to a transformer. If the correspondence is appropriate, the document can be stored and if not, the document is rejected.

The step of identifying 425 can be performed by instructions corresponding to computer software which may be executed by a computing system or device.

During the step of identifying 425, a prompt representative of a request for identification of segments of the document can be provided to a transformer. These identified segments can be stored in a database or computer memory.

The step of evaluating 430 can be performed by instructions corresponding to computer software which may be executed by a computing system or device.

During the step of evaluating 430, a prompt representative of a request for quantification of the quality of a document can be provided to a transformer. The quantified quality score can be stored in a database or computer memory and used in a downstream step of selecting a document.

In particular embodiments, such as the one shown in FIG. 3, the method 300 object of the present invention further comprises prior to the step of initially generating 310, a step of configuring 370 at least one document generation rule, at least one step of generating, 310 and/or 335, being performed as a function of said configured at least one document generation rule.

The step of configuring 370 can be performed by instructions corresponding to computer software which may be executed by a computing system or device.

During the step of configuring 370, rules corresponding to present document generation or modification instructions may be set by a user or a system.

In particular embodiments, such as the one shown in FIG. 3, the method 300 object of the present invention further comprises after a step of generating, 310 and/or 335, a step of operating 375 an agent configured to confirm or infirm the conformity of the digital document to the at least one document generation or modification parameter value sent.

The step of operating 375 can be performed by instructions corresponding to computer software which may be executed by a computing system or device.

During the step of operating 375, the generated document is provided to the agent, along with the generation instructions and with a conformity verification request, which can take the form of a text instruction to the agent for example.

In particular embodiments, such as the one shown in FIG. 3, the method 300 object of the present invention further comprises, after a step of generating, 310 and/or 335, a step of operating 380 an agent configured to confirm or infirm the quality of the digital document to the at least one document generation or modification parameter value sent.

The step of operating 380 can be performed by instructions corresponding to computer software which may be executed by a computing system or device.

During the step of operating 380, the generated document is provided to the agent, along with a quality verification request, which can take the form of a text instruction to the agent for example.

In particular embodiments, such as the one shown in FIG. 3, the method 300 object of the present invention further comprises, after a step of generating, 310 and/or 335, a step of operating 385 an agent configured to confirm or infirm the veracity of the digital document to the at least one document generation or modification parameter value sent.

The step of operating 385 can be performed by instructions corresponding to computer software which may be executed by a computing system or device.

During the step of operating 385, the generated document is provided to the agent, along with a veracity verification request, which can take the form of a text instruction to the agent for example.

In particular embodiments, such as the one shown in FIG. 3, the method 300 object of the present invention further comprises, after a step of generating, 310 and/or 335, a step of operating 390 an agent configured to confirm or infirm the coherency of the digital document to the at least one document generation or modification parameter value sent.

The step of operating 390 can be performed by instructions corresponding to computer software which may be executed by a computing system or device.

During the step of operating 390, the generated document is provided to the agent, along with a coherency verification request, which can take the form of a text instruction to the agent for example.

In particular embodiments, such as the one shown in FIG. 3, the method 300 object of the present invention further comprises, after a step of operating, 375, 380, 385, and/or 390, if the respect of the corresponding criteria is infirmed by the agent, the step of creating 395 a digital request of document generation, comprising at least one document modification parameter value, the step of generating, 310 and/or 335, being further performed as a function of said at least one document modification parameter value.

The step of operating 395 can be performed by instructions corresponding to computer software which may be executed by a computing system or device.

During the step of creating 395, at least one document modification parameter value is automatically generated in a request of document generation, the request taking the form of a text instruction or prompt.

It should therefore be understood that the agents act as a collection of experts which interact in a transparent manner, as all the instructions created and transmitted between one another are recorded and made available for audit by a user or system.

FIG. 2 represents, schematically, a particular embodiment of the system 200 object of the present invention. This system 200 of iterative document generation, comprises at least:
an output device 205, configured to send a generation SMTP message, from a computing device 210 associated with a user to a document generator 215, said message comprising a digital request of document generation, comprising at least one document generation parameter value,
said computing device,
a document generator, configured to initially generate a digital document as a function of said at least one document generation parameter value,
storing means 220, configured to store the generated digital document on a computing storage 225,
said computing storage,
access link obtaining means 230, configured to obtain an access link to the location of the generated digital document on the computer storage,
an output device 205 configured to iteratively send to a computing device associated with said user, a message representative of the availability of the generated digital document at the obtained access link,
an output device 205, configured to send a modification SMTP message, from a computing device associated with said user to a document generator, comprising a digital request of document modification, comprising at least one document modification parameter value, the document generator further configured to generate a modified digital document as a function of said at least one document modification parameter value,
the document generator further configured to generate a modified digital document as a function of said at least one document modification parameter value and of the said at least one document generation parameter value, and,
the storing means further configured to store the modified digital document on the computer storage.

Particular embodiments of the means of said systems are disclosed in relation to FIG. 2.

As it is understood, the present invention also aims at a computer program product which comprises instructions which upon execution by a computer cause the computer to execute the method object of the present invention.

As it is understood, the present invention also aims at a computer-readable storage medium storing programming instructions which upon execution by a computer cause the computer to execute the method object of the present invention.

1. Method of iterative document generation, which comprises at least the steps of:
sending a generation message, from a computing device associated with a user to a document generator, comprising a digital request of document generation, comprising at least one document generation parameter value,
initially generating, by the document generator, a digital document as a function of said at least one document generation parameter value,
storing, on a computing storage, the generated digital document,
obtaining an access link to the location of the digital document generated on the computer storage,
then, iteratively:
sending, to a computing device associated with said user, a message representative of the availability of the generated digital document at the obtained access link,
sending a modification SMTP message, from a computing device associated with said user to a document generator, comprising a digital request of document modification, comprising at least one document modification parameter value,
generating, by the document generator, a modified digital document as a function of said at least one document modification parameter value and of the said at least one document generation parameter value, and
storing, on a computing storage, the modified digital document.

2. Method according to claim 1, which further comprises, prior to the step of sending a modification SMTP message, the steps of:
selecting, upon a computing device, a part of the generated or modified digital document, and
associating, upon a computer device, at least one document modification parameter value in relation to said selected part,
the step of sending a modification SMTP message being performed as a function of the at least one document modification parameter value in relation to said selected part.

3. Method according to claim 1, which further comprises, prior to the step of initially generating, the steps of:
collecting, upon a computing storage, at least one previously available digital document,
anonymizing, by a computing device, the content of the collected at least one digital document,
tagging, by a computing device, the content of anonymized content of the collected at least one digital document,
said tagged anonymized content being used during the step of generating a digital document.

4. Method according to claim 3, which further comprises at least one of the steps of:
classifying the collected documents,
summarizing the collected documents,
converting at least one collected document to text format,
checking that type of at least one collected document corresponds to a predetermined expected document type,
identifying segments of the at least one collected document,
evaluating the quality of the at least one collected document.

5. Method according to claim 1, which further comprises, prior to the step of initially generating, a step of configuring at least one document generation rule, at least one step of generating being performed as a function of said configured at least one document generation rule.

6. Method according to claim 1, which further comprises, after a step of generating, a step of operating an agent configured to confirm or infirm the conformity of the digital document to the at least one document generation or modification parameter value sent.

7. Method according to claim 1, which further comprises, after a step of generating, a step of operating an agent configured to confirm or infirm the quality of the digital document to the at least one document generation or modification parameter value sent.

8. Method according to claim 1, which further comprises, after a step of generating, a step of operating an agent configured to confirm or infirm the veracity of the digital document to the at least one document generation or modification parameter value sent.

9. Method according to claim 1, which further comprises, after a step of generating, a step of operating an agent configured to confirm or infirm the coherency of the digital document to the at least one document generation or modification parameter value sent.

10. Method according to claim 6, which further comprises, after a step of operating, if the respect of the corresponding criteria is infirmed by the agent, the step of creating a digital request of document generation, comprising at least one document modification parameter value, the step of generating being further performed as a function of said at least one document modification parameter value.

11. System of iterative document generation, which comprises at least:
an output device, configured to send a generation SMTP message, from a computing device associated with a user to a document generator, said message comprising a digital request of document generation, comprising at least one document generation parameter value,
said computing device,
a document generator, configured to initially generate a digital document as a function of said at least one document generation parameter value,
storing means, configured to store the generated digital document on computing storage,
said computing storage,
access link obtaining means, configured to obtain an access link to the location of the generated digital document on the computer storage,
an output device configured to iteratively send to a computing device associated with said user, a message representative of the availability of the generated digital document at the obtained access link,
an output device, configured to send a modification SMTP message, from a computing device associated with said user to a document generator, comprising a digital request of document modification, comprising at least one document modification parameter value,
the document generator further configured to generate a modified digital document as a function of said at least one document modification parameter value and of the said at least one document generation parameter value, and
the storing means further configured to store the modified digital document on the computer storage.

12. Computer program product which comprises instructions which upon execution by a computer cause the computer to execute the method according to Method according to claim 1.

13. Computer-readable storage medium storing programming instructions which upon execution by a computer cause the computer to execute the method according to Method according to claim 1.
